(19) United States
(12) Patent Application Publication
(10) Pub. No.: US 2012/0265150 A1
(43) Pub. Date: Oct. 18, 2012

(54) INJECTOR DEVICE FOR ADMINISTERING MULTIPLE DOSES IN A SINGLE DELIVERY, AND METHODS OF MANUFACTURE

(75) Inventors: Charles M. Frey, Bozrah, CT (US); Michael Basil, East Hampton, CT (US)

(73) Assignee: PLAS-PAK INDUSTRIES, INC., Norwich, CT (US)

(21) Appl. No.: 13/086,773

(22) Filed: Apr. 14, 2011

(51) Int. Cl. A61D 7/00; B23P 17/00

(52) U.S. Cl. 604/191; 29/527.1

(57) ABSTRACT

An injector device for dispensing at least two fluids in a sequential delivery includes a plunger located within an inner body, the inner body located within an outer body, a cannula comprising an entry opening integrally joined to the outer body, and at least one piercing member integrally joined with the outer body. In an embodiment, the piercing member includes a neck section and one or more slots that engage a membrane on the inner body so as to continue to allow release of the contents of a first liquid from the outer body just prior to commencement of the flow of a second liquid from the inner body.

### FIELD

This disclosure generally relates to a single delivery device designed to contain two or more different liquids for sequential delivery into a non-human and method of manufacturing such a device.

### BACKGROUND

Mastitis is an inflammatory reaction of breast tissue caused by a bacterial, chemical, thermal or mechanical injury and is one of the most common and costly diseases of dairy cattle. The inflammatory response results in an increase of blood protein and white blood cells in the mammary tissue and milk and reduces the desirable milk components, such as milk fat and casein. Treating dairy cattle typically requires restraining them in a squeeze chute, thorough cleaning of the teat end and orifice, inserting an injector filled with an antibiotic into the teat canal, and a separate second injector containing a barrier formulation for sealing the teat canal. Such a dual injection system can result in a stretched and/or damaged inner teat canal, which leaves a temporary hole or conduit for bacterial contamination after the antibiotic injector is withdrawn and before the sealing injector is inserted to seal the teat canal.

It is known to treat a teat canal with a single delivery device containing two components for sequential delivery of an antibiotic in a first stage firing and a barrier seal in a second stage firing. While such a device minimizes introduction of bacteria from a second injector and provides an ease of use for a technician, such a device relies on an activator and valve system that are difficult to manufacture and transport without accidental rupture, contains added components that require additional assembly, and is more likely to malfunction.

It is also known to treat a teat canal with a sequential multiple dose single delivery device having a thin-wall membrane on an inner barrel that engages one or more sharp objects on an outer barrel so as to cause the membrane to rupture. However, such a device does not allow the release of the entire contents of the first liquid from the outer barrel prior to the injection of the second liquid from the inner barrel. This results in an undesirable amount of a first liquid remaining in the outer barrel at the time that the membrane ruptures, which causes undesirable mixing. Further, an uncontrolled rupture of the membrane upon engagement with an object creates a risk that fragments of the membrane will break off and be injected into the teat canal, thereby further aggravating the mastitis and creating tissue damage.

There is therefore a need for a sequential delivery injector that is easy to manufacture, assembly and transport that also reliably punctures an inner membrane without dislodging any fragments, while minimizing undesirable mixing between the first and second firing stages. Furthermore, there is a need for creating an improved piercing member.

### SUMMARY

In an embodiment, an injector device for dispensing at least two fluids in a sequential delivery includes an outer body having a proximal end, a distal end, a longitudinal axis, and a first cavity for containing a first fluid, the outer body substantially closing the first cavity at the proximal end and being opened at the distal end; a cannula comprising an entry opening integrally joined at the proximal end of the outer body, the entry opening in fluid communication with the first cavity; an inner body located within the outer body, the inner body having a second cavity for containing a second fluid, the inner body including a close fit within the outer body so as to form a first piston to be pushed through the distal end of the outer body, the first piston comprising a membrane section that forms a fluid tight seal between the outer body and the inner body; a plunger located within the inner body, the plunger including a close fit within the inner body so as to form a second piston to be pushed through the second cavity; and at least one piercing member within the outer body. The piercing member has a base section integrally joined to the outer body, a neck section integrally joined to the base section, the neck section extending within the first cavity in a plane that is substantially perpendicular to the membrane section, the neck section comprising an outer perimeter, a plurality of slots integrally formed along the outer perimeter of the neck section, the slots in fluid communication with the entry opening. Upon movement of the plunger and the first piston toward the proximal end, the first liquid is discharged through the entry opening until the membrane section penetrates the neck section whereby the second liquid is discharged through the slots.

The above described and other features are exemplified by the following detailed description.

### DETAILED DESCRIPTION

The present inventors have discovered that a single injector device that allows for sequential delivery stages of multiple fluids can be molded with less components to assemble that minimizes risk of accidental rupture, and reduces mixing between stages. The injector device has an inner body comprising a membrane and an outer body comprising a piercing member comprising one or more slots that engages the membrane so as to continue to allow release of the contents of the first liquid from the outer body just prior to commencement of the flow of a second fluid from the inner body. The injector device provides a piercing member that reliably slices the membrane to form one or more flaps surrounding the slots so as to minimize mixing between delivery stages of the fluids. The piercing member further minimizes any risk of dislodgment of pieces of the membrane and minimizes further inflammation of the teat canal.

Referring to embodiments illustrated in FIGS. 1-3 of the attached drawings, wherein like numerals are used to designate like parts throughout, an injector device 10 is shown as cylindrical in shape, the cross-section being through the axis of the longitudinal cylinder in the direction of the arrows labeled A and B. As used herein, the terms “proximal” and distal” are used with respect to the injection site so that a proximal end is the end closest to the injection site and a distal end is the furthest from the injection site, along the longitudinal direction of the arrows labeled A and B. The terms “lateral” and “central” are used to with respect to a transversal direction of the arrows labeled C and D so that the central end is closest to the longitudinal axis of the injector device and the lateral end is the end furthest from the longitudinal axis. The injector device 10 comprises an outer body 12, an inner body 14, a plunger 16, the later being of a reduced diameter than the former and telescoping within the former. The injector device 10 further comprises a cannula 18, a through bore 20, a piercing member 22, an entry opening 24, and a cap 26.

The cap 26 comprises of an outer cap 28 and an inner cap 30 that is fitted over the cannula 18 in order to remain hygienically clean prior to use. The cannula 18 is injected into the teat canal. Upon applying pressure in the proximal direction of the device, delivery of the liquid is passed through the through bore 20. While it should be understood that the cannula 18 as shown is designed to be inserted into a teat canal of a dairy cattle, the cannula can be configured for injection into other animals and other applications. The cannula 18 is cooperatively sized to form a leak resistant interfit with the outer cap 28 and inner cap 30. Removal of the outer cap 28 and exposure of a cannula tip 32 allows for a known partial insertion technique that treats mastitis, as described in U.S. Pat. No. 5,059,172, which limits insertion of the cannula to a predefined depth. Removal of both the outer cap 28 and inner cap 30 allows for full insertion of the cannula 18.

The outer body 12 is generally in the shape of a an elongated cylindrical cup, with a open face 34 towards the distal end, a substantially closed face 36 towards the proximal end, an inner side wall 38 facing the central end, and an outer side wall 40 towards the lateral end. The entry opening 24 is located at the closed face 36. The cannula 18 is integrally connected to the closed face 36 of the outer body 12 so that the entry opening 24 is in fluid communication with the through bore 20. In an embodiment, the cannula is not separately molded and attached to the outer body.

As explained in more detail below, the piercing member 22 lies inside the outer body 12 and is integrally joined to the closed face 36. The piercing member is of sufficient length to pierce a fluid tight membrane 42 as the inner body 14 approaches the proximal limit of travel. The piercing member is integrally molded with the outer body so as to minimize assembly of components. The piercing member is not separately molded and attached to the outer body.

The inner body 14 is generally in the shape of an elongated cylindrical cup with a fluid tight membrane 42 towards the proximal end of the device, an open end 44 towards the distal end of the device, an exterior wall 46 towards the lateral end and an interior wall 48 towards the central end. The inner side wall 38 of the outer body 12 is formed to engage the exterior wall 46 of the inner body 14.

The plunger 16 is slidable mounted in the inner body 14 and includes a cylindrical shaft 50 that extends off of the inner body 14, a thumb pad 52 at its distal end, and a surface portion 54 at the proximal end of the plunger 16. The surface portion 54, which can be of a larger diameter than the remainder of the cylindrical shaft 50, provides a fluid tight seal between the plunger 16 and the interior wall 48 of the inner body 14.

The fluid-tight membrane 42 is integrally joined with the inner body 14 at the proximal end and extends across the inner body 14, dividing the interior of the injector device 10 into two separate fluid receiving cavities, a first cavity 56 that contains a first liquid 58 and a second cavity 59 that contains a second liquid 60. The first cavity 56 is formed from the inner side wall 38 of the outer body 38, the closed face 36, and a proximal surface 62 of the membrane 42. The second cavity 59 is formed from interior wall 48 of the inner body 14, a distal surface 64 of the membrane 42, and a proximal section 66 of the plunger 16.

The piercing member 20 is not introduced to the second fluid in the second cavity until the second firing process has begun. Thus, any particulates in the second fluid that may be present in the second cavity 59 will not settle on the entry opening 54, and accordingly this reduces the possibility that the entry opening would become clogged.

FIGS. 1, 2 and 3 show cross-sectional views of the injector device 10 in a two-stage firing sequence of fluids from the first cavity 56 and second cavity 59. Referring to FIG. 1, in the first firing, a force labeled E is applied in the proximal direction of the device to the plunger 16, which is then translated to the second liquid 60. The second liquid 60 is compressed until it reaches a threshold in which the force then acts upon the first liquid 58 to urge the first liquid 58 through the entry opening 24 and with the outer cap removed (not shown), the first liquid is expelled out through the through bore 20. As the first liquid 58 is expelled, the exterior wall 46 of the inner body 14 slidingly engages the inner side wall 38 of the outer body 12 while maintaining a fluid tight seal between the first and second cavities. At this time, the inner body 14, plunger 16, and the fluid in the second cavity 59 move as one unit and acts as a first piston for delivery of the contents from the outer body 12.

As the force E continues to be applied to the plunger 16 and the second liquid 60, the proximal surface 62 of the membrane 42 engages the piercing member 22 and the membrane 42 is pierced.

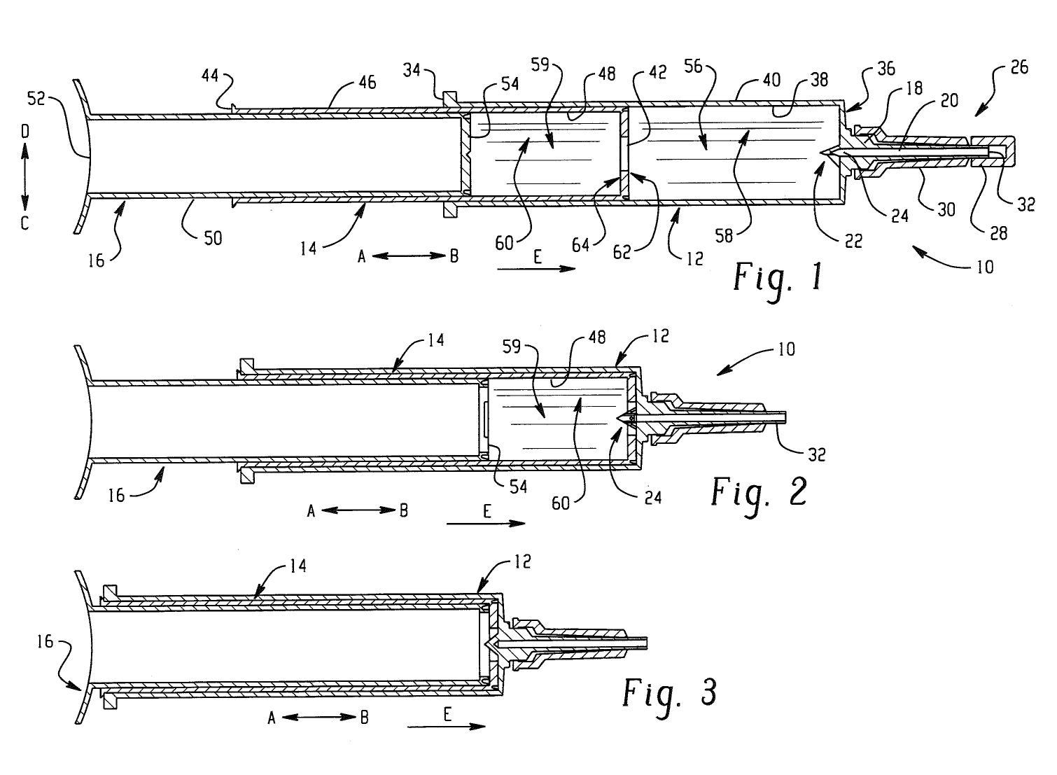

FIG. 2 shows a completed first stage firing of the fluid from the first cavity 56. The second firing commences when a fluid pathway is created between the first and second cavities, and virtually all of the first fluid has drained out through the entry opening 24. In the embodiment as shown in FIG. 2, at least 99% by volume of the first fluid has drained out through the entry opening 24 prior to commencement of the second firing. As the force E is applied to the plunger 16, the inner body 14 no longer slidingly moves along the inner side wall 38, and now the plunger 16 slidingly moves towards the proximal end of the device 10, and acts as a second piston. As the plunger 16 moves within the interior wall 48, the second liquid 60 is ejected through the entry opening 24. The plunger 16 continues to move into the inner body 14 until the proximal side of the surface portion 54 reaches a terminal point in which virtually all of the fluid in the second cavity is expelled through the entry opening 24. FIG. 3 shows a completed first and second stage firing.

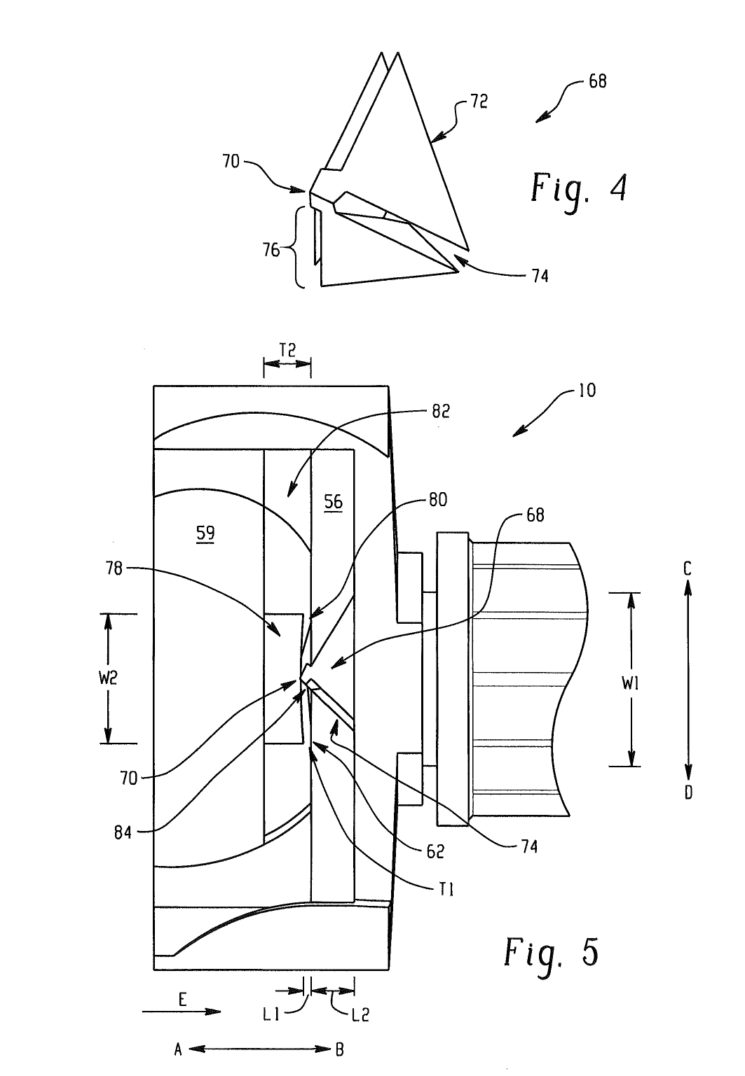

Referring to FIGS. 4-6, there is shown an embodiment of a piercing member in a design of a pyramid member 68, and like parts are assigned the same reference numbers. FIG. 4 is an isolated external perspective view of the pyramid member 68 comprising an apex 70 towards the distal end, a base 72 towards the proximal end, a plurality of slots 74, and a neck section 76. The base 72 is integrally connected to the closed face 36. The plurality of slots 74 surrounds the pyramid member 68 and is in fluid communication with the entry opening 24.

FIG. 5 shows a perspective view of a portion of the pyramid member 68 just prior to completion of the first firing. The apex 70 towards the distal end has a length L1, and the neck section 76 has a length L2, both as measured in the direction of the arrows A and B. The neck section comprises a series of panels and slots. The base has a width of W1 as measured in the direction of the arrows C and D. In this embodiment, a groove 78 having a width W2 divides the membrane 42 into a central membrane 80 having a thickness T1 and a lateral membrane 82 having a thickness T2, wherein T2 is great than T1. In a preferred embodiment, W1 is approximately the same size as W2. The central membrane 80 can be further designed with one or more indentations (not shown) to be more readily pierced by the pyramid 68 and peel back in a preconfigured pattern.

As shown in FIG. 5, as the force E is applied, the apex 70 pierces the central membrane 80 and a flap 84 is formed from the membrane. The flap 84 initially surrounds the perimeter of the apex just prior to the second stage firing, and continues to maintain the fluid tight seal between the first cavity 56 and second cavity 59. This in turn allows most of the remaining fluid from the first cavity 56 to be squeezed through the entry opening 24 prior to the second stage firing.

As the proximal surface 36 of the membrane reaches the neck section 76, the second cavity 59 is exposed so that the slot 74 is in fluid communication with the second cavity, thereby allowing commencement of the second firing. As the membrane 42 continues to traverse length L2 towards the base 72 of the pyramid member 68, the flap 84 is stretched over the neck section to further expose the slot 74, thereby increasing the fluid communication between the second cavity 59 and entry opening 24. In general, the size and shape of the slots are determined from a typical amount of pressure exerted by a user's thumb that minimizes pressure build up and allows for virtually all evacuation.

FIG. 6 shows a perspective view of a portion of the pyramid after the first and second firings and collapse of both cavities. As shown, the central membrane 80 is sliced nearly to the boundary of the lateral membrane 82, extending over the width W1. In this embodiment, the pyramid 68 generally formed a plurality of flaps. By limiting the formation of the flaps 84 to the central membrane 80, the lateral membrane 82 is not pierced, which allows the lateral membrane to continue to squeeze out any remaining fluid left in the first cavity, while minimizing mixing of both liquids in the device. In an embodiment, the base of the piercing member is approximately the same size as the central membrane.

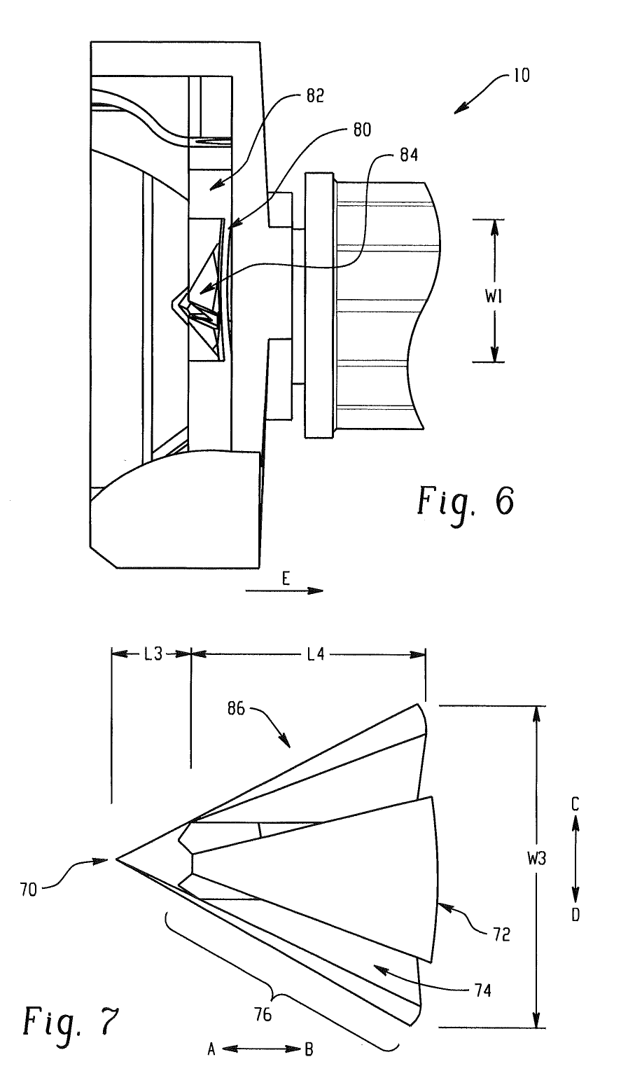

Referring to FIGS. 7-9, there is shown an alternative embodiment of a piercing member in a design of a center-point member 86, and like parts are assigned the same reference numbers. FIG. 7 is an isolated external perspective view of the center-point 86 comprising an apex 70, towards the distal end, a base 72 towards the proximal end, a plurality of slots 74, and a neck section 76. The base 72 is integrally connected to the closed face 36. The plurality of slots 74 surrounds the center point member 86 and is in fluid communication with the entry opening 24. The apex 70 towards the distal end has a length L3, and the neck section 76 has a length L4, both as measured in the direction of the arrows A and B. The base has a width of W3 as measured in the direction of the arrows C and D.

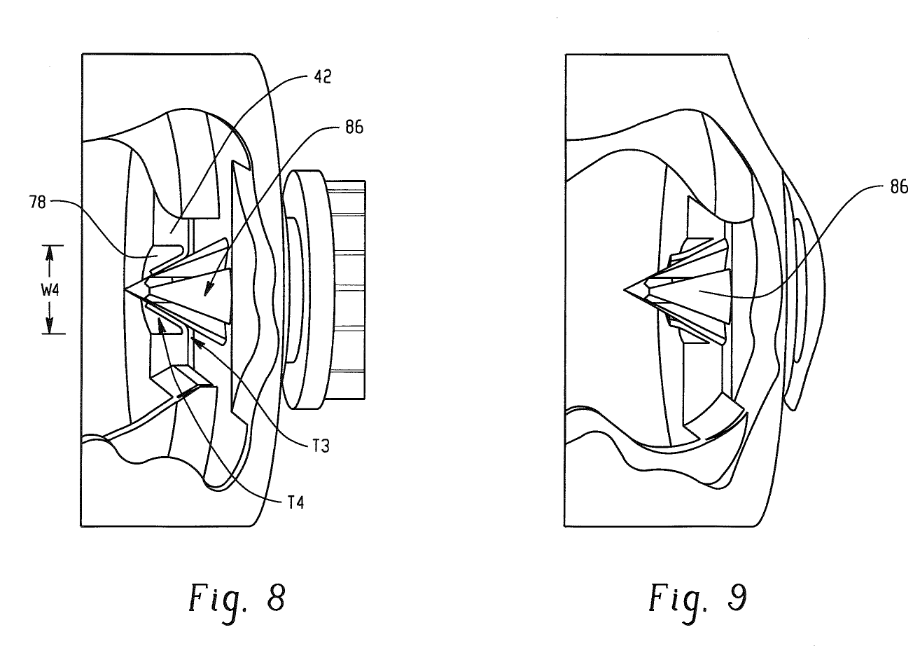

FIG. 8 shows a perspective view of a portion of the center-point 86 just prior to completion of the first firing. In this embodiment, a groove 78 having a width W4 that divides the membrane 42 into a central membrane 80 having a thickness T3 and a lateral membrane 82 having a thickness T4.

FIG. 9 shows a perspective view of a portion of the center-point member 86 after the first firings and commencement of the second firing. The first cavity has collapsed. The center-point member 86 is configured to pierce and slice open the central membrane in a manner similarly described in the pyramid design, one of the differences being that the center-point member more aggressively engages the membrane with a sharper apex. Further, the proximal surface of the plunger can comprise a notch (not shown) that is designed to complement the shape of the center-point 86 in order to more fully expunge the liquid out of the second cavity 59.

In the center-point embodiment disclosed in FIGS. 7-9, the center-point member 86 projects further into the first cavity and pierces further into second cavities 59 than the pyramid embodiment disclosed in FIGS. 4-6. By extending the height of the apex in the center-point embodiment, a sharper point can be made to pierce the central membrane 80, which in turn allows the design of a thicker membrane that is more resistant to accidental rupture.

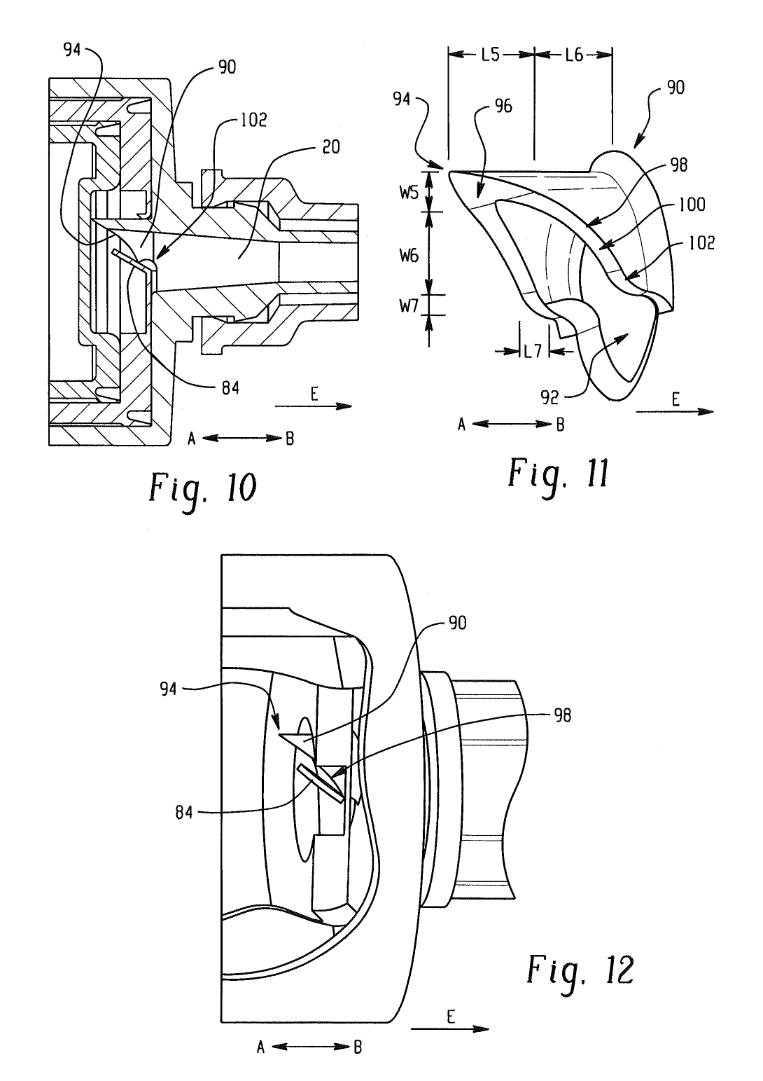

Referring to FIGS. 10-13, there is shown an alternative embodiment of a piercing member in a design of a hollow cylindrical member 90, and like parts are assigned the same reference numbers. FIG. 10 is a cross-sectional view of the cylindrical member 90 extending in the direction as shown by the arrows A and B. Inside the cylindrical member 90 is a hole 92 in which fluid can pass into the through bore 20. FIG. 11 is an isolated external perspective view of the cylindrical member 90.

Referring both to FIGS. 10, and 11, the cylindrical member comprises a top edge 94, a first beveled face 96, a second edge 98, a second bevel face 100, and a choil face 102. As used herein, a “choil” is defined as a section of the cylindrical member that does not a have a cutting edge. The top edge 94 is the end of the cylindrical member 90 that is used for piercing the membrane. At the top edge 94, the first beveled face 96 is formed having a length L5 as shown in the direction by the arrows A and B, and a width W5 as shown in the direction by the arrows C and D.

The second edge 98 provides a cutting surface of the cylindrical member 90 that extends from the top edge 94 to the choil face 102, and forms the perimeter of the second beveled face 100. The second bevel face 100 has a length L6 and a width W6. As shown more clearly in FIG. 11, the second bevel face 102 is generally concave, which yields a sharper second edge 98. Other shapes to the beveled faces can be formed to achieve optimal balance between strength of edges verses sharpness.

As shown in FIG. 11, the top edge 94 and second edge 98 are beveled at an acute angle to form a cutting edge that results in a shearing or slicing action when engaging the central membrane 80. This produces a smooth puncture of the membrane rather than a ragged puncture, and minimizes fragmentation of the membrane.

The choil face 102 discontinues the slicing action of the second edge 98, and generally provides a smooth surface for the flap 84 to slide over as force E is applied. As the flap 84 slides over the choil face 102, it is hinged open to release the contents of the second cavity 59. As shown, the choil face 102 has a length L7 in the direction of the arrows A and B, and a width W7 that is now measurable in the direction as shown by the arrows C and D. In order to achieve a proper hingement of the flap 84 against the choil face, an angle of inclination of the choil face as measured against the closed face 36 is preferably greater than seventy-five degrees, more preferably greater than eight degrees, and even more preferably at least ninety degrees.

Just prior to the second edge further slicing the flap and upon slicing action of only the top edge 94 (not shown), the flap 84 maintains a fluid tight seal with the first beveled face 96 and the second beveled face 100. This in turn allows the remainder of fluid from the first cavity 56 to flow through the hole 92 just as the flap engages the second edge and choil face.

FIG. 12 shows a perspective view of a portion of the cylindrical member 90 piercing the central membrane 80 and forming the flap 84 at the commencement of the second firing. In this embodiment, the top edge 94 has pierced through the central membrane 80 and the second edge 98 has cut through the central membrane 80 and formed the flap 84. The second edge has further sliced the flap 84.

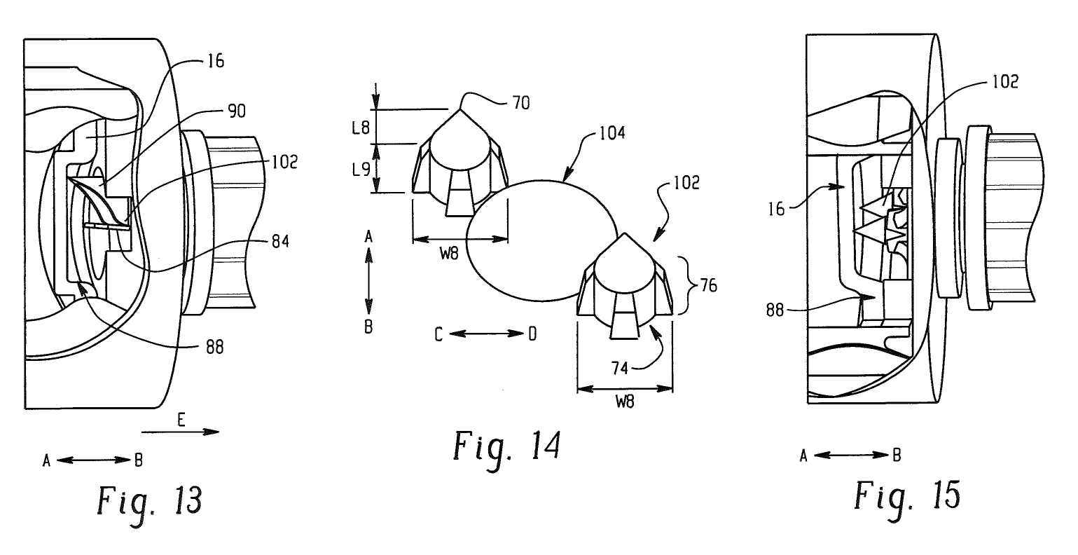

FIG. 13 shows another perspective view of a portion of the cylindrical member 90 and the central membrane 80 after completion of the first firing and second firing. As shown, the flap 84 has been cut along the second edge 98 until it reached the choil face 76. At this point, the flap is no longer cut, and as the choil 102 hinges open the flap 84. As shown, the fluid tight seal between the first cavity 56 and second cavity is broken, and the fluid from the second cavity has flowed through the hole. A notch 88 is can optionally be molded into the plunger so as to form a complementary fitting to the piercing member and to maximize the amount of fluid expunged during the second firing.

Referring to FIGS. 14-15, there is shown an alternative embodiment of a piercing member in a design of a twin-point member 78, and like parts are assigned the same reference numbers. FIG. 14 is an isolated external perspective view of the twin-point member 102 comprising an apex 70 towards the distal end, a plurality of slots 74, and a channel 104 for fluids to flow into upon firing.

FIG. 15 shows a perspective view of a portion of the twin-point member 102 at completion of the first and second firing, and collapse of the first and second cavities. The twin-point member 102 comprises at least two points that are integrally formed with the closed face and project into the interior of the outer body 12. Both points have an apex 70 towards the distal end that has a length L8, and a neck section 76 has a length L9, both as measured in the direction of the arrows A and B. The base of both points has a width of W8 as measured in the direction of the arrows C and D. The plunger comprises a notch 88 that is designed to complement the shape of the twin-point member 102 in order to more fully expunge the liquid out of the second cavity 59.

As described in the previous embodiments, the twin-point member engages the central membrane 80 in a similar fashion to the center-point member. The difference in the twin-point design is that two apexes engage the membrane, and the membrane is torn from point to point. Additionally, by moving the piercing members towards the lateral side of the entry opening, the piercing member is more easily molded. Further, one advantage of the twin point design is that the channel 104 allows for highly viscous sealants to pass through with minimal back pressure. In an embodiment, the injector device is manufactured in an injection molding machine in which heated thermoplastic is forced under pressure into a mold. After the thermoplastic cools, the mold is separated along a part line and a molded thermoplastic part is ejected. The injector can be molded from three molds that form the plunger, the inner body, and the outer body, respectively. The outer body, piercing member, and cannula can be integrally molded together so that no assembly is required to form these components, and further, that those components will not disassemble or dislodge especially during shipping and handling. The central membrane, lateral membrane and inner body can be integrally molded so that no assembly is required to form these components.

In an alternative embodiment, a two-shot molding process can be used to manufacture an elastomer membrane and a rigid inner body.

The resins selected for molding the outer body, the inner body, and plunger can be selected to provide resistance to degradation by the material to be placed therein and provide a reliable puncturing of the membrane without fragmentation. Generally, thermoplastic resins such as polyolefins and polyamides are suitable, with polypropylene being preferred because of its strength and inertness. For greater ease of sliding motion between the outer body, inner body, and plunger, each such component can be fabricated of a dissimilar material having specific characteristics, i.e., the outer body can be fabricated of material having a different coefficient of friction relative to the inner body to facilitate the sliding motion or restrict such motion as desired. In an embodiment, the outer body, inner body, and plunger are each fabricated from different types of resins comprising high density, medium density, and low density polyethylene.

In an exemplary embodiment, the outer body is constructed with high density polyethylene or a copolymer polypropylene, and the inner body is constructed with a lower density polymer, such as a medium density or low density polyethylene. In a further embodiment, the plunger can be constructed with a high density or medium density polyethylene, and the cap can be constructed of low density polyethylene.

In a specific embodiment, the outer body is constructed of high density polyethylene, the inner body is constructed of low density polyethylene, the plunger is constructed of high density or medium density polyethylene, and the cap is constructed of low density polyethylene.

The material used for the membrane can also be a thermoplastic resin and provide a frangible surface that slices open upon engagement with the piercing member. In a preferred embodiment, the membrane will withstand an injection thumb force of around 10 to 20 pounds during injection, more preferably 13 to 18 pounds, and even more preferably 14 to 16 pounds.

Additional applications for the injector device include applications for sequential delivery of different liquids that need to be separated prior to delivery. For example, the injector device can be used for delivering vitamins and minerals.

Various configurations of the piercing member can be made to achieve the same purpose. For example, bevel angles can be adjusted optimize to maximize shearing action while maintaining sufficient strength of the edges and ease of manufacturing. Different types of faces can be designed to include features that are similar to knife sharpening designs such as hollow ground, flat ground, saber ground, chisel ground, compound bevel and convex ground.

In an embodiment, an injector device for dispensing at least two fluids in a sequential delivery includes an outer body having a proximal end, a distal end, a longitudinal axis, and a first cavity for containing a first fluid, the outer body substantially closing the first cavity at the proximal end and being opened at the distal end; a cannula comprising a through bore located at the proximal end of the outer body in fluid communication with the first cavity; an inner body located within the outer body, the inner body having a second cavity for containing a second fluid, the inner body including a close fit within the outer body so as to form a first piston to be pushed through the distal end of the outer body, the first piston comprising a membrane section that forms a fluid tight seal between the outer body and the inner body; a plunger located within the inner body, the plunger including a close fit within the inner body so as to form a second piston to be pushed through the second cavity; and at least one piercing member within the outer body. The piercing member extends within the first cavity in a plane that is substantially perpendicular to the membrane section, the piercing member defining a substantially cylindrical hollow form in fluid communication with the through bore, the piercing member configured to engage the membrane to form at least one flap covering the hollow form. The piercing member includes a choil face arranged to open the flap in order to allow the second liquid to be released from the second cavity.

In a further embodiment, the outer body, the cannula, and the piercing member can comprise a first polymeric material, and the inner body and the membrane can comprise a second polymeric material that is different from the first. The first and second polymeric materials can be selected from the group consisting of high density polyethylene, medium density polyethylene, low density polyethylene, copolymer polypropylene, polyolefin and polyamide. The injector device can have a second edge that is beveled. The injector device can also have a choil face that includes a smooth surface. The membrane can have a central section and a lateral section, the central section having a thickness that is less than the lateral section. The piercing member can be configured for engagement with the membrane to provide a direct passageway for delivery of the second fluid into the through bore. The plunger can include a notch that is complementary in shape and opposite to the piercing member.

In another embodiment, a method of producing an injector device for dispensing at least two fluids in a sequential delivery includes (a) injection molding a first polymeric material to form a first barrel section, wherein injection molding of the first barrel section includes forming an open-ended cannula tip defining a cannula outlet at a proximal end of the first barrel section, forming an outer body section in fluid connection with the cannula outlet via a through bore between the outer body section and the cannula outlet, forming a piercing member to define a neck section and a plurality of slots, the slots positioned along an outer perimeter of the neck section, the slots in fluid communication between the outer body section and the through bore, and forming an opening at a distal end of the first barrel section in connection with the outer body; (b) injection molding a second polymeric material to form an inner body that is open at one end, wherein injection molding the inner body includes forming a membrane at a proximal end of the inner body, and forming an opening at a distal end of the inner body in connection with the barrel section; (c) injection molding a third polymeric material to form a plunger; and (d) assembling the first barrel section, inner body, and plunger to form the device. The first polymeric material can be different from the second polymeric material. The second polymeric material can be different from the third polymeric material. The first, second, and third polymeric materials can be selected from the group consisting of high-density polyethylene, medium density polyethylene, low-density polyethylene, copolymer polypropylene, polyolefin and polyamide.

As used herein the transitional term “comprising,” (also “comprises,” etc.) which is synonymous with “having”, “including,” “containing,” or “characterized by,” is inclusive or open-ended and does not exclude additional, unrecited elements or method steps, regardless of its use in the preamble or the body of a claim.

The singular forms “a,” “an,” and “the” include plural referents unless the context clearly dictates otherwise.

The endpoints of all ranges directed to the same characteristic or component are independently combinable, and inclusive of the recited endpoint.

The word “or” means “and/or.”

Reference throughout the specification to “one embodiment”, “other embodiments”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed as the best mode contemplated for carrying out this invention, but that the invention will include all embodiments falling within the scope of the appended claims.

1. An injector device for dispensing at least two fluids in a sequential delivery comprising:
an outer body having a proximal end, a distal end, a longitudinal axis, and a first cavity for containing a first fluid, the outer body substantially closing the first cavity at the proximal end and being opened at the distal end;
a cannula comprising an entry opening integrally joined at the proximal end of the outer body, the entry opening in fluid communication with the first cavity;
an inner body located within the outer body, the inner body having a second cavity for containing a second fluid, the inner body including a close fit within the outer body so as to form a first piston to be pushed through the distal end of the outer body, the first piston comprising a membrane section that forms a fluid tight seal between the outer body and the inner body;
a plunger located within the inner body, the plunger including a close fit within the inner body so as to form a second piston to be pushed through the second cavity; and
at least one piercing member within the outer body, the piercing member having
a base section integrally joined to the outer body,
a neck section integrally joined to the base section, the neck section extending within the first cavity in a plane that is substantially perpendicular to the membrane section, the neck section comprising an outer perimeter,
a plurality of slots integrally formed along the outer perimeter of the neck section, the slots in fluid communication with the entry opening,
whereby upon movement of the plunger and the first piston toward the proximal end, the first liquid to be discharged through the entry opening until the membrane section penetrates the neck section whereby the second liquid to be discharged through the slots.

2. The injector device of claim 1 further wherein the outer body, the cannula, and the piercing member comprise a first polymeric material.

3. The injector device of claim 2 wherein the inner body and the membrane comprise a second polymeric material.

4. The injector device of claim 3 wherein the first polymeric material is different from the second polymeric material.

5. The injector device of claim 3, wherein the first and second polymeric materials are selected from the group consisting of high density polyethylene, medium density polyethylene, low density polyethylene, copolymer polypropylene, polyolefin and polyamide.

6. The injector device of claim 1 comprising two or more piercing members.

7. The injector device of claim 1 comprising at least three slots.

8. The injector device of claim 1 wherein the piercing member is configured for engagement with the membrane to provide a direct passageway for delivery of the second fluid through the plurality of slots into the entry opening.

9. The injector device of claim 1 wherein the membrane comprises a central section and a lateral section, the central section having a thickness that is less than the lateral section.

10. The injector device of claim 1 wherein the plunger comprises a notch that is complementary in shape and opposite to the piercing member.

11. An injector device for dispensing at least two fluids in a sequential delivery comprising:
an outer body having a proximal end, a distal end, a longitudinal axis, and a first cavity for containing a first fluid, the outer body substantially closing the first cavity at the proximal end and being opened at the distal end;
a cannula comprising a through bore located at the proximal end of the outer body in fluid communication with the first cavity;
an inner body located within the outer body, the inner body having a second cavity for containing a second fluid, the inner body including a close fit within the outer body so as to form a first piston to be pushed through the distal end of the outer body, the first piston comprising a membrane section that forms a fluid tight seal between the outer body and the inner body;
a plunger located within the inner body, the plunger including a close fit within the inner body so as to form a second piston to be pushed through the second cavity; and
at least one piercing member within the outer body, the piercing member extending within the first cavity in a plane that is substantially perpendicular to the membrane section, the piercing member defining a substantially cylindrical hollow form in fluid communication with the through bore, the piercing member configured to engage the membrane to form at least one flap covering the hollow form,
the piercing member comprising
a choil face arranged to open the flap in order to allow the second liquid to be released from the second cavity.

12. The injector device of claim 11, wherein the outer body, the cannula, and the piercing member comprise a first polymeric material.

13. The injector device of claim 12 wherein the inner body and the membrane comprise a second polymeric material.

14. The injector device of claim 13 wherein the first polymeric material is different from the second polymeric material.

15. The injector device of claim 14, wherein the first and second polymeric materials are selected from the group consisting of high density polyethylene, medium density polyethylene, low density polyethylene, copolymer polypropylene, polyolefin and polyamide.

16. The injector device of claim 11 wherein the second edge is beveled.

17. The injector device of claim 11 wherein the choil face comprises a smooth surface.

18. The injector device of claim 11 wherein the piercing member is configured for engagement with the membrane to provide a direct passageway for delivery of the second fluid into the through bore.

19. The injector device of claim 11 wherein the membrane comprises a central section and a lateral section, the central section having a thickness that is less than the lateral section.

20. The injector device of claim 11 wherein the plunger comprises a notch that is complementary in shape and opposite to the piercing member.

21. A method of producing an injector device for dispensing at least two fluids in a sequential delivery, comprising:
(a) injection molding a first polymeric material to form a first barrel section, wherein injection molding of the first barrel section comprises:
forming an open-ended cannula tip defining a cannula outlet at a proximal end of the first barrel section,
forming an outer body section in fluid connection with the cannula outlet via a through bore between the outer body section and the cannula outlet,
forming a piercing member to define a neck section and a plurality of slots, the slots positioned along an outer perimeter of the neck section, the slots in fluid communication between the outer body section and the through bore, and
forming an opening at a distal end of the first barrel section in connection with the outer body;
(b) injection molding a second polymeric material to form an inner body that is open at one end, wherein injection molding the inner body comprises:
forming a membrane at a proximal end of the inner body, and
forming an opening at a distal end of the inner body in connection with the barrel section;
(c) injection molding a third polymeric material to form a plunger; and
(d) assembling the first barrel section, inner body, and plunger to form the device.

22. The method of claim 21, wherein the first polymeric material is different from the second polymeric material.

23. The method of claim 21, wherein the second polymeric material is different from the third polymeric material.

24. The method of claim 21, wherein the first, second, and third polymeric materials are selected from the group consisting of high density polyethylene, medium density polyethylene, low density polyethylene, copolymer polypropylene, polyolefin and polyamide.
